(19) United States
(12) Patent Application Publication
(10) Pub. No.: US 2024/0004564 A1
(43) Pub. Date: Jan. 4, 2024

(54) ELECTRONIC CONTROL UNIT, AREA ALLOCATION METHOD, AND STORAGE MEDIUM STORING AREA ALLOCATION PROGRAM

(71) Applicants: DENSO CORPORATION, Kariya-city (JP); TOYOTA JIDOSHA KABUSHIKI KAISHA, Toyota-shi (JP)

(72) Inventors: Tomohiro TAKAHASHI, Kariya-city (JP); Kenshi INOTANI, Nagakute-shi (JP); Norihide KOHMOTO, Nisshin-shi (JP)

(21) Appl. No.: 18/342,769

(22) Filed: Jun. 28, 2023

(30) Foreign Application Priority Data
Jul. 4, 2022 (JP) 2022-107790

(51) Int. Cl. G06F 3/06

(52) U.S. Cl. CPC G06F 3/0631; G06F 3/0604; G06F 3/0679

(57) ABSTRACT

By an electronic control unit, an area allocation method, or a computer-readable non-transitory storage medium storing an area allocation program, an area securement request is accepted from an area securement request application, it is determined whether a capacity of an unallocated area of a storage exceeds a request capacity, a part of unused area of an allocated area already allocated to an area-allocated application is release as a release area, a total capacity of at least a part of the capacity of the unallocated area and a capacity of the release area is allocated as the allocated area.

### CROSS REFERENCE TO RELATED APPLICATION

The present application claims the benefit of priority from Japanese Patent Application No. 2022-107790 filed on Jul. 4, 2022. The entire disclosure of the above application is incorporated herein by reference.

### TECHNICAL FIELD

The present disclosure relates to an electronic control unit, an area allocation method, and a storage medium storing an area allocation program.

### BACKGROUND

For example, an in-vehicle electronic control unit (hereinafter referred to as an ECU) is configured to store various data in a storage.

### SUMMARY

By an electronic control unit, an area allocation method, or a computer-readable non-transitory storage medium storing an area allocation program, an area securement request is accepted from an area securement request application, it is determined whether a capacity of an unallocated area of a storage exceeds a request capacity, a part of unused area of an allocated area already allocated to an area-allocated application is release as a release area, a total capacity of at least a part of the capacity of the unallocated area and a capacity of the release area is allocated as the allocated area.

### BRIEF DESCRIPTION OF DRAWINGS

FIG. 1 is a functional block diagram according to a first embodiment.

FIG. 2 is a diagram showing an allocation management table.

FIG. 3 is a diagram showing a manner of allocating an allocated area of an area securement request application.

FIG. 4 is a diagram showing a manner of updating the allocation management table.

FIG. 5 is a diagram showing a manner of allocating the allocated area of the area securement request application.

FIG. 6 is a diagram showing a manner of updating the allocation management table.

FIG. 7 is a flowchart.

FIG. 8 is a flowchart.

FIG. 9 is a flowchart.

FIG. 10 is a diagram showing a flow of processes.

FIG. 11 is a diagram showing a flow of processes.

FIG. 12 is a diagram showing a flow of processes.

FIG. 13 is a diagram showing a flow of processes.

FIG. 14 is a flowchart showing a second embodiment.

FIG. 15 is a flowchart.

FIG. 16 is a flowchart.

FIG. 17 is a flowchart showing a third embodiment.

FIG. 18 is a flowchart.

FIG. 19 is a flowchart.

FIG. 20 is a flowchart.

### DETAILED DESCRIPTION

In an in-vehicle environment, there is an increasing need to store various data in storage due to increasing legal requirements and image analysis needs. A configuration in which a storage is individually provided for each ECU is not efficient from viewpoints of cost, installation space, centralized management of data, and the like. Under such circumstances, a configuration in which multiple applications share a storage is assumed. In the configuration in which multiple applications share the storage, upon receiving an area securement request from an area securement request application, the request capacity in the storage capacity specified by the area securement request is allocated as an allocated area of the area securement request application.

In this case, it is possible to allocate all of or a part of the capacity of the unallocated area as the allocated area of the area securement request application when the capacity of an unallocated area of the storage at the time of receiving the area securement request from the area securement request application exceeds the request capacity. However, it is not possible to allocate all of or a part of the capacity of the unallocated area as the allocated area of the area securement request application when the capacity of the unallocated area of the storage does not exceed the request capacity.

One example of the present disclosure provides an electronic control unit, an area allocation method, and an area allocation program capable of appropriately allocating an allocated area of an area securement request application when a capacity of an unallocated area of a storage does not exceed a request capacity at a time of accepting an area securement request from the area securement request application.

According to one example embodiment, an area securement request acceptance unit accepts an area securement request from an area securement request application. An area determination unit determines whether a capacity of an unallocated area of the storage exceeds a request capacity specified by the area securement request upon acceptance of the area securement request from the area securement request application. An area release unit releases, as a release area, at least a part of unused area of the allocated area already allocated to an area-allocated application when a capacity of the unallocated area of the storage does not exceed the request capacity. An area allocation unit allocates a total capacity of at least a part of the capacity of the unallocated area and a capacity of the release area as the allocated area in response to the area securement request.

According to another example embodiment, an area allocation method causes an electronic control unit to cause multiple applications to share a storage. The method includes: accepting an area securement request from an area securement request application; determining whether a capacity of an unallocated area of the storage exceeds a request capacity specified by the area securement request; releasing, as a release area, at least a part of unused area of the allocated area already allocated to an area-allocated application when a capacity of the unallocated area of the storage does not exceed the request capacity; and allocating a total capacity of at least a part of the capacity of the unallocated area and a capacity of the release area as the allocated area in response to the area securement request.

Further, according to another example embodiment, a computer-readable non-transitory storage medium stores an area allocation program for a controller of an electronic control unit that causes multiple applications to share a storage. The program causes the controller to: accept an area securement request from an area securement request application; determine whether a capacity of an unallocated area of the storage exceeds a request capacity specified by the area securement request; release, as a release area, at least a part of unused area of the allocated area already allocated to an area-allocated application when a capacity of the unallocated area of the storage does not exceed the request capacity; and allocate a total capacity of at least a part of the capacity of the unallocated area and a capacity of the release area as the allocated area in response to the area securement request.

Focusing on the situation that the unused area exists in the allocated area already allocated to the area-allocated application, when the capacity of the unallocated area of the storage does not exceed the request capacity, at least a part of the unused area is released as the released area, and the total capacity of at least a part of the unallocated area and the release area is allocated as the allocated area of the area securement request application. By releasing a part of the unused area as the release area and allocating the total capacity of the part of the unallocated area and the release area as the allocated area of the area securement request application, it is possible to secure the allocated area of the area securement request application. Thereby, when the capacity of the unallocated area of the storage 3 does not exceed the request capacity at the time of receiving the area securement request from the area securement request application, it is possible to appropriately allocate the allocated area of the area securement request application.

Hereinafter, multiple embodiments will be described with reference to the drawings. In the following description, descriptions of same configurations as the ones described in the preceding embodiment may be omitted for simplification. An application may mean software in general for causing an ECU to execute processes for implementing a specific function, and include concepts of threads and modules.

### First Embodiment

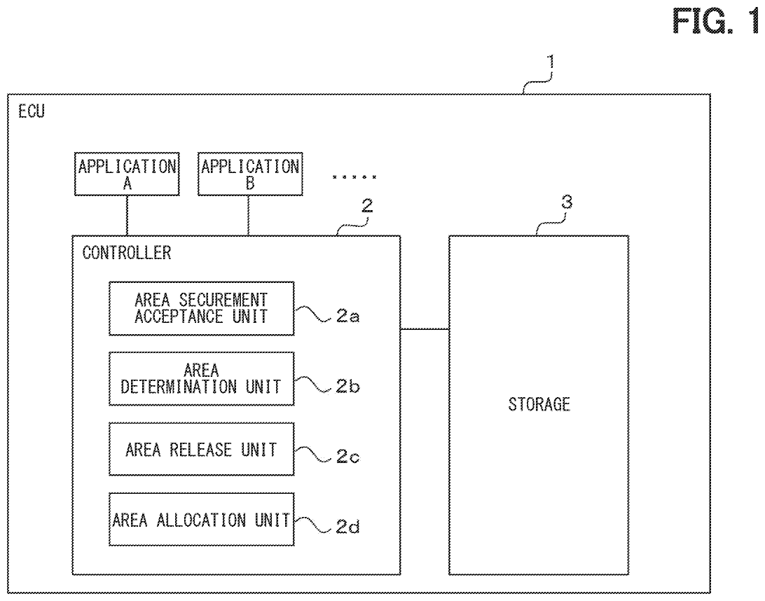

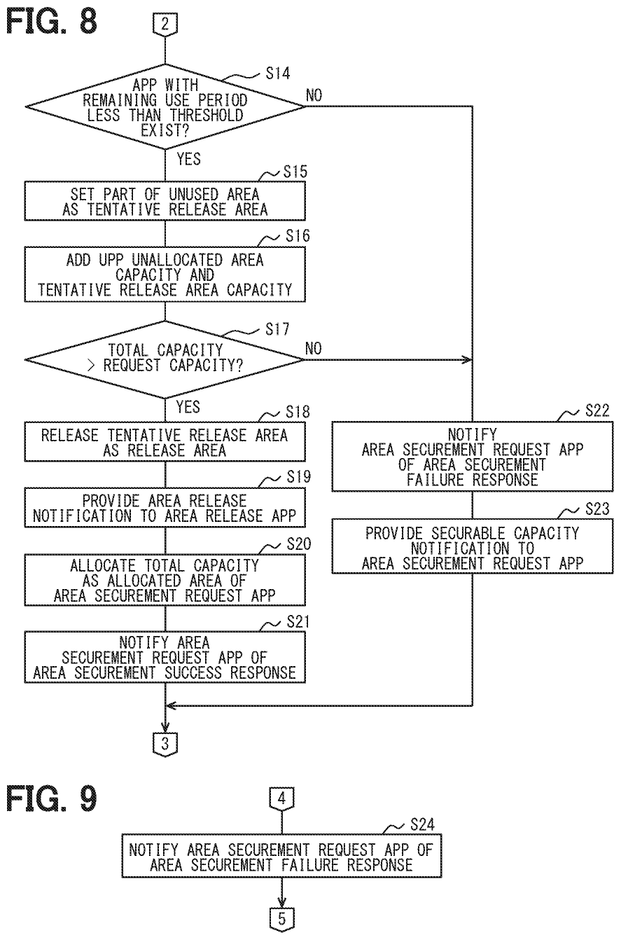

A first embodiment will be described with reference to FIG. 1 to FIG. 13. As shown in FIG. 1, an ECU 1 mounted on a vehicle is, for example, an integration management ECU that integrally manages multiple ECUs (not shown), and has a function as a central gateway. The ECU 1 is connected to multiple ECUs via an in-vehicle network so as to enable data communication, and the ECU 1 integrally manages the multiple ECUs by instructing an operation command to the multiple ECUs, acquiring an operation state of the multiple ECUs and the like. The in-vehicle network is, for example, CAN (Controller Area Network, registered trademark), Ethernet (registered trademark), LIN, CXPI (Clock Extension Peripheral Interface, registered trademark), FLEXRAY (registered trademark), MOST (Media Oriented Systems Transport, registered trademark), or the like.

The ECU 1 includes a controller 2 and a storage 3. The controller 2 is provided by a microcomputer having a CPU (Central Process Unit), a ROM (Read Only Memory), a RAM (Random Access Memory), and an I-O (Input-Output). By executing a control program stored in a non-transitory tangible storage medium, the controller 2 executes a process corresponding to the control program, and controls the overall operation of the ECU 1. The control program executed by the controller 2 includes an area allocation program.

The storage 3 is a nonvolatile memory mainly including, for example, a NOR flash memory or a NAND flash memory, and is shared by multiple applications executed by the controller 2. That is, multiple applications each access the storage 3 to write and read data. Although the configuration in which the storage 3 is built in the ECU 1 is exemplified in the present embodiment, it may be also possible to apply a configuration in which the storage 3 is arranged outside the ECU 1. Further, although the configuration in which the storage 3 is shared by multiple applications executed by the controller 2 is illustrated, the application executed by the control unit of another ECU connected to the ECU 1 for data communication may share the storage 3.

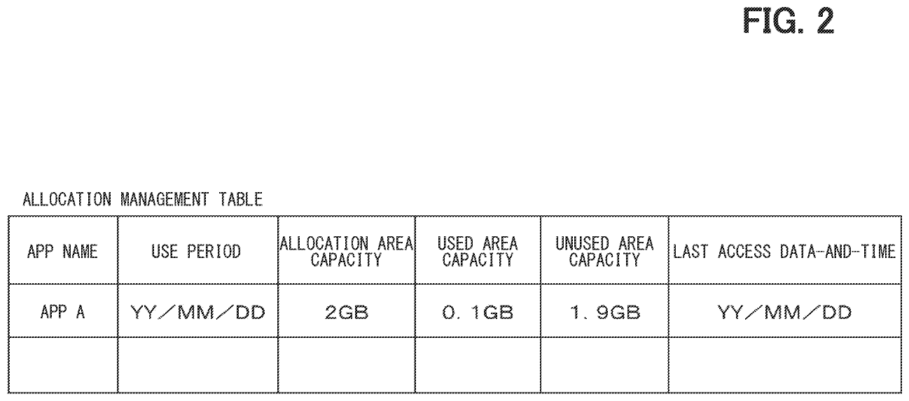

The controller 2 manages allocation of areas of the storage 3 using the allocation management table shown in FIG. 2. The allocation management table is a table in which items such as application name, use period, allocated area capacity, used area capacity, unused area capacity, and last access date-and-time are used as records. The meaning of each item is as follows.

The application name means a name of an application that provides a notification of the area securement request. The application that provides the notification of the area securement request is an area securement request application. The use period means a use period of the storage 3, is provided as the notification from the area securement request application, and means a use end time.

The allocated area capacity means a capacity of an area allocated for the area securement request application in the areas of the storage 3. The application to which the allocated area is allocated due to the notification of the area securement request is an area-allocated application. The used area capacity means a capacity of an area that is used by the area securement request application and is in the allocated area, and is a capacity of an area in which data has been written.

The unused capacity area means a capacity of an area that is unused by the area securement request application and is in the allocated areas, and is a capacity of an area in which data has not been written. The capacity is a capacity obtained by subtracting the used area capacity from the allocated area capacity.

The last access date-and-time means a date and time when the application last accessed the allocated area, and a date and time when a file was last opened.

The controller 2 includes an area securement request reception unit 2a, an area determination unit 2b, an area release unit 2c, and an area allocation unit 2d. These units 2a to 2d constitute the area allocation program. The area securement request reception unit 2a receives the area securement request from the area securement request application by receiving the notification of the area securement request from the area securement request application. When the area securement request reception unit 2a receives the area securement request from the area securement request application, the area allocation unit 2d allocates, as the allocated area of the area securement request application, the request capacity specified by the area securement request in the areas of the storage 3.

In this case, since the storage 3 is shared by multiple applications, the capacity of the unallocated area of the storage 3 may be insufficient for the requested capacity specified by the area securement request. Regarding this point, the area allocation unit 2d allocates the request capacity as the allocated area in cooperation with the area determination unit 2b and the area release unit 2c as follows. The area determination unit 2b compares the capacity of the unallocated area of the storage 3 with the request capacity. When the area determination unit 2b determines that the capacity of the non-allocated area exceeds the request capacity, that is, determines that the capacity of the unallocated area is sufficient, the area allocation unit 2d allocates, as the allocated area for the area securement request application, a capacity according to the area securement request in the capacity of the unallocated area.

On the other hand, when the area determination unit 2b determines that the capacity of the unallocated area does not exceed the request capacity, that is, determines that the capacity of the unallocated area is insufficient, the area allocation unit 2d notifies the area release unit 2c of an area release request. When receiving the area release request from the area allocation unit 2d, the area release unit 2c determines whether an application whose access frequency to the allocated area is less than a threshold or an application with an allocated area remaining use period less than a threshold exists among the area-allocated applications.

The access frequency is an index based on a time from the last access date-and-time to the current time. When the time from the last access date-and-time to the current time is relatively long, the access frequency value is relatively small. When the time from the last access date-and-time to the current time is relatively short, the access frequency value is relatively large. The remaining use period is an index based on the time from the current time to the use end time indicated by the use period. When the time from the current time to the use end time indicated by the usage period is relatively long, the value of the remaining use period is relatively large. When the time from the current time to the use end time indicated by the use period is relatively short, the value of the remaining use period is relatively small.

When determining that the application whose access frequency to the allocated area is less than a threshold or the application with the allocated area remaining use period less than the threshold exists among the area-allocated applications, the area release unit 2c selects the application as an area release application. After selecting the area release application, the area release unit 2c releases, as a release area, at least part of the unused area of the allocated area already allocated to the selected area release application. When the release area is released by the area release unit 2c, the area allocation unit 2d allocates at least part of the capacity of the allocated area and the capacity of the release area as the allocated area of the area securement request application.

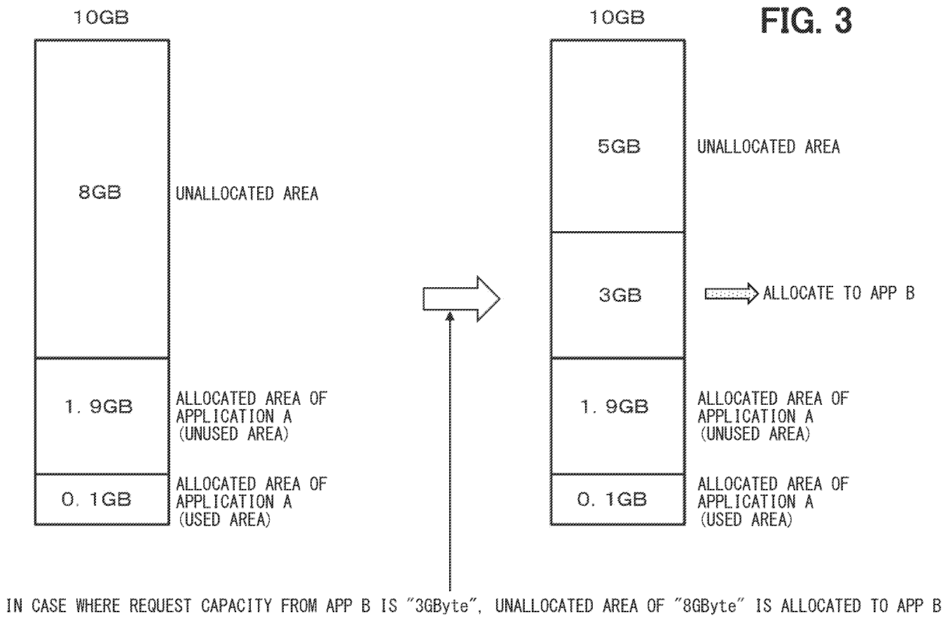

Specifically, it will be described with reference to FIGS. 3 to 6. In this case, as an example, it is described that the area securement request is received from an application B when the capacity of the storage 3 is “10 GByte”, the capacity of the allocated area of an application A is “2 GByte”, the capacity of the used area of the allocated area of the application A is “0.1 GByte”, and the capacity of the unused area is “1.9 GByte”. That is, in this case, the capacity of the unallocated area is “8 GByte” obtained by subtracting “2 GB” of the capacity of the allocated area for the application A from “10 GB” of the capacity of the storage 3. The application A is the area-allocated application, and the application B is the area securement request application. At this time, the area allocation unit 2d holds the allocation management table shown in FIG. 2.

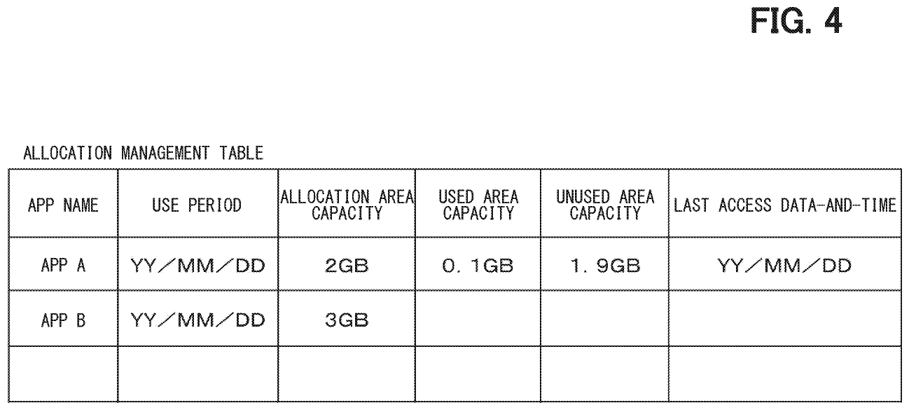

As shown in FIG. 3, when the request capacity from application B is, for example, “3 GByte”, the area allocation unit 2d determines that the unallocated area capacity of “8 GByte” exceeds the request capacity of “3 GByte”. Therefore, “3 GByte” in “8 GByte” of the unallocated area is allocated as the allocated area of the application B. When the allocation of the allocated area is successful, the area allocation unit 2d notifies the application B of an area securement success response indicating that the allocation has been successful. At this time, the area allocation unit 2d adds a record of the application B to the allocation management table as shown in FIG. 4.

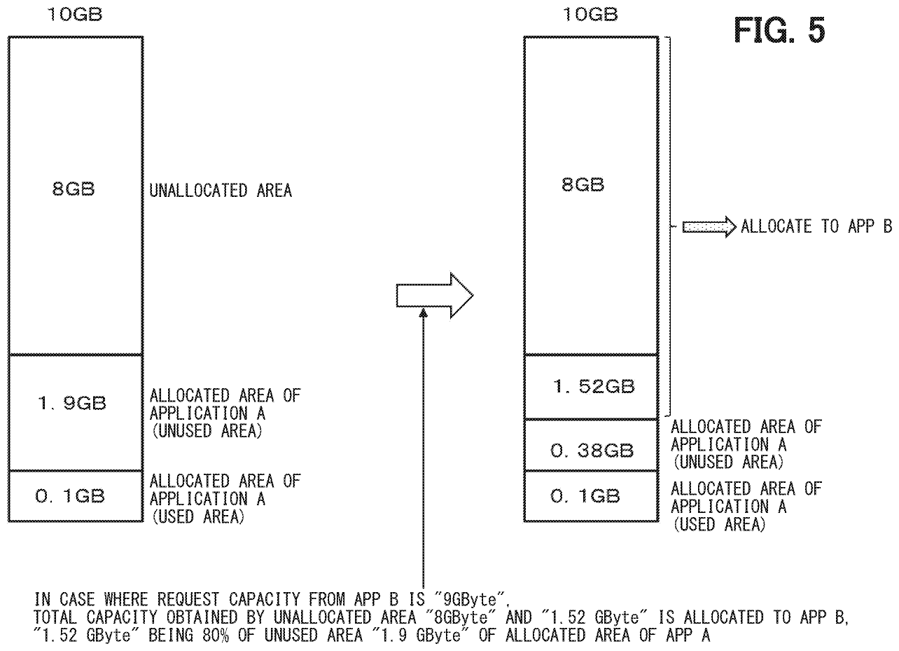

As shown in FIG. 5, when the request capacity from application B is, for example, “9 GByte”, the area allocation unit 2d determines that the unallocated area capacity of “8 GByte” does not exceed the request capacity of “9 GByte”. Therefore, the area allocation unit 2d notifies the area release unit 2c of the area release request. When the area release unit 2c receives the area release request from the area allocation unit 2d and the access frequency to the allocated area of the application A is less than the threshold or the remaining use period of the allocated area of the application A is less than the threshold, the area release unit 2c selects the application A as the area release application.

When selecting the application A as the area release application, the area release unit 2c sets, to a tentative release area, a part of the unused area, for example, “80%”, of the allocated area already allocated to the application A selected as the area release application. The area release unit 2c calculates the total capacity by adding up the unallocated area of “8 GByte” and “1.52 GByte” that is “80%” of the unused area of “1.9 GByte” in the allocated area of “2 GByte” already allocated to the application A. Since the calculated total capacity of “9.52 GByte” exceeds the request capacity of “8 GByte”, the area release unit 2c releases the tentative release area as the release area.

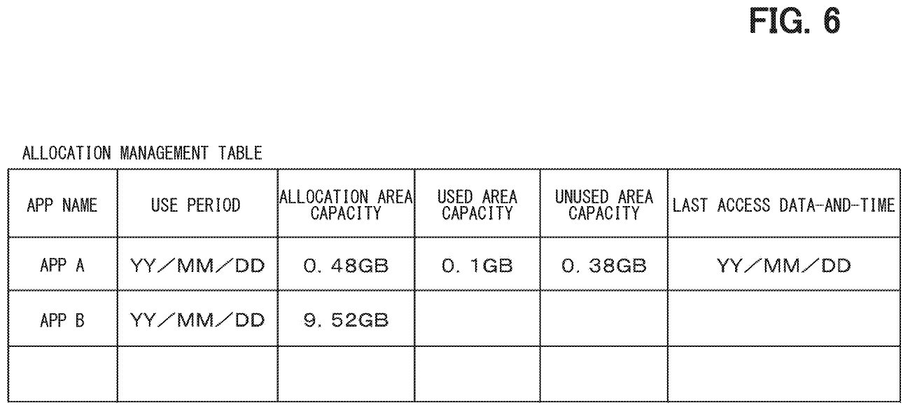

When the release area is released by the area release unit 2c, the area allocation unit 2d notifies the application A of the area release notification indicating that a part of the unused area has been released, and allocates the total capacity as the allocated area of the application B. When the allocation of the allocated area is successful, the area allocation unit 2d notifies the application B of an area securement success response indicating that the allocation has been successful. At this time, the area allocation unit 2d updates the record of the application A in the allocation management table and adds a record of the application B to the allocation management table as shown in FIG. 6.

In the above example, it is described that the area release unit 2c sets, as the tentative release area, for example, “80%” that is a part of the unused area of the allocated area already allocated to the application A selected as the area release application. However, a capacity that at least satisfies the request capacity from application B may be set as the tentative release area. That is, the area release unit 2c may subtract “8 GByte” that is the capacity of the unallocated area, from “9 GByte” that is the request capacity from the application B, and calculate the shortage as “1 GByte”. The area release unit 2c may set, as the tentative release area, the “1 GByte” that is a part of the unused area of the allocated area already allocated to the application A.

When the access frequency to the allocated area for the application A is not less than the threshold and the remaining use period of the allocated area for the application A is not less than the threshold, the area release unit 2c does not select the application A as the area release application. When the allocation of the allocated area fails, the area allocation unit 2d notifies the application B of an area securement failure response indicating that the allocation has failed, and notifies the application B of a securable capacity notification representing the securable capacity. At this time, the area allocation unit 2d does not add a record of the application B to the allocation management table.

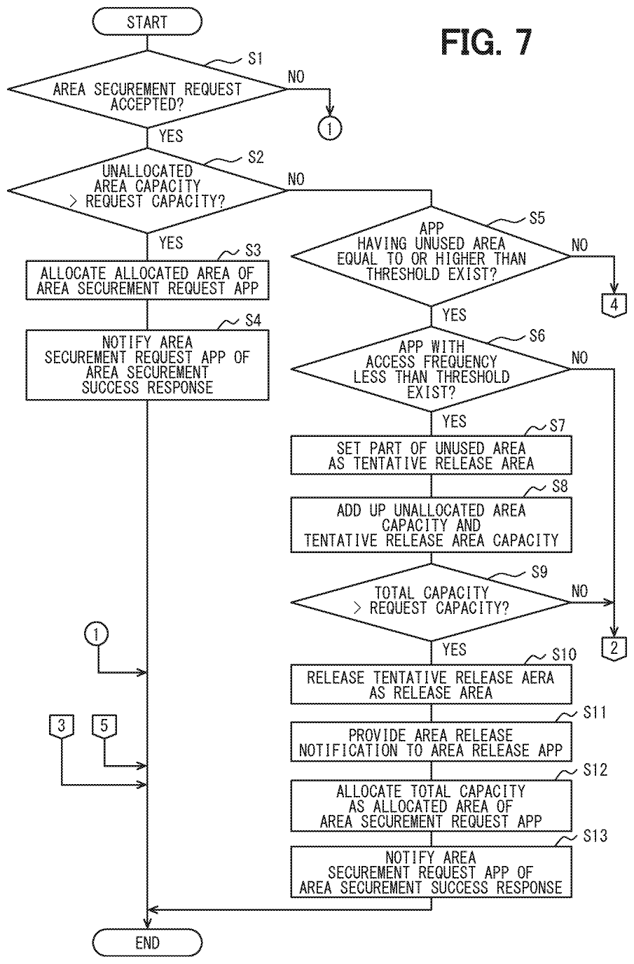

Next, the operation of the above configuration will be described with reference to FIGS. 7 to 13. When a condition for starting an area securement request acceptance process is established, the controller 2 starts the area securement request acceptance process, and determines whether the area securement request from the area securement request application has been received (S1). When determining that the area securement request from the area securement request application has not been accepted (S1: NO), the controller 2 ends the area securement request acceptance process and waits until a condition for starting the next area securement request acceptance process is established.

When determining that the area securement request from the area securement request application has been accepted (S1: YES, corresponding to an area securement request acceptance process), the controller 2 compares the capacity of the unallocated area of the storage 3 with the request capacity specified by the area securement request to determine whether the capacity of the unallocated area exceeds the request capacity (S2, corresponding to an area determination process). When determining that the capacity of the unallocated area exceeds the request capacity (S2: YES), the controller 2 allocates, as the allocated area of the area securement request application, the capacity according to the area securement request in the capacity of the unallocated area (S3). When notifying the area securement request application of the area securement success response (S4), the controller 2 ends the area securement request acceptance process and waits until a condition for starting the next area securement request acceptance process is established.

On the other hand, when determining that the capacity of the unallocated area does not exceed the request capacity (S2: NO), the controller 2 determines whether an application having an unused area equal to or larger than the threshold exists among the area-allocated applications (S5). When determining that the application having an unused area equal to or larger than the threshold (S5: YES) exists, the controller 2 determines whether an application whose access frequency to the allocated area is less than the threshold exists (S6).

When determining that the application whose access frequency to the allocated area is less than the threshold exists (S6: YES), the controller 2 sets a part of the unused area of the allocated area of the application as the tentative release area (S7). The controller 2 adds up the capacity of the unallocated area and the capacity of the tentative release area to calculate the total capacity (S8), compares the calculated total capacity with the request capacity, and determines whether the total capacity exceeds the request capacity (S9).

When determining that the total capacity exceeds the request capacity (S9: YES), the controller 2 releases the tentative release area as the release area (S10, corresponding to an area release process), and sends the area release notification to the area release application (S11), and allocates the total capacity as the allocated area of the area securement request application (S12, corresponding to an area allocation process). That is, the controller 2 allocates, as the allocated area of the area securement request application, the total capacity of the capacity of the unallocated area and the capacity of a part of the unused area of the allocated area of the application whose access frequency to the allocated area is less than the threshold. When notifying the area securement request application of the area securement success response (S13), the controller 2 ends the area securement request acceptance process and waits until a condition for starting the next area securement request acceptance process is established.

When determining that no application whose access frequency to the allocated area is less than the threshold exists (S6: NO), or when determining that the total capacity does not exceed the request capacity (S9: NO), the controller 2 determines whether the application whose remaining use period of the allocated area is less than the threshold exists (S14). When determining that the application whose remaining use period of the allocated area is less than the threshold exists (S14: YES), the controller 2 sets a part of the unused area of the allocated area of the application as the tentative release area (S15). The controller 2 adds up the capacity of the unallocated area and the capacity of the tentative release area to calculate the total capacity (S16), compares the calculated total capacity with the request capacity, and determines whether the total capacity exceeds the request capacity (S17).

When determining that the total capacity exceeds the request capacity (S17: YES), the controller 2 releases the tentative release area as the release area (S18), and sends the area release notification to the area release application (S19), and allocates the total capacity as the allocated area of the area securement request application (S20). That is, the controller 2 allocates, as the allocated area of the area securement request application, the total capacity of the capacity of the unallocated area and the capacity of a part of the unused area of the allocated area of the application whose allocated area remaining use period is less than the threshold. When notifying the area securement request application of the area securement success response (S21), the controller 2 ends the area securement request acceptance process and waits until a condition for starting the next area securement request acceptance process is established.

When determining that the application whose allocated area remaining use period is less than the threshold exists (S14: NO) or when determining that the total capacity does not exceed the request capacity (S17: NO), the controller 2 notifies the area securement request application of the area securement failure response (S22), notifies the area securement request application of the securable capacity notification indicating the securable capacity (S23), ends the area securement request acceptance process, and waits until the condition for starting the next area securement request acceptance process is established. The controller 2 may not notify the area securement request application of the securable capacity notification. When determining that the application having the unused area equal to or larger than the threshold (S5: NO), the controller 2 notifies the area securement request application of the area securement failure response (S24) and ends the area securement request acceptance process and waits until a condition for starting the next area securement request acceptance process is established.

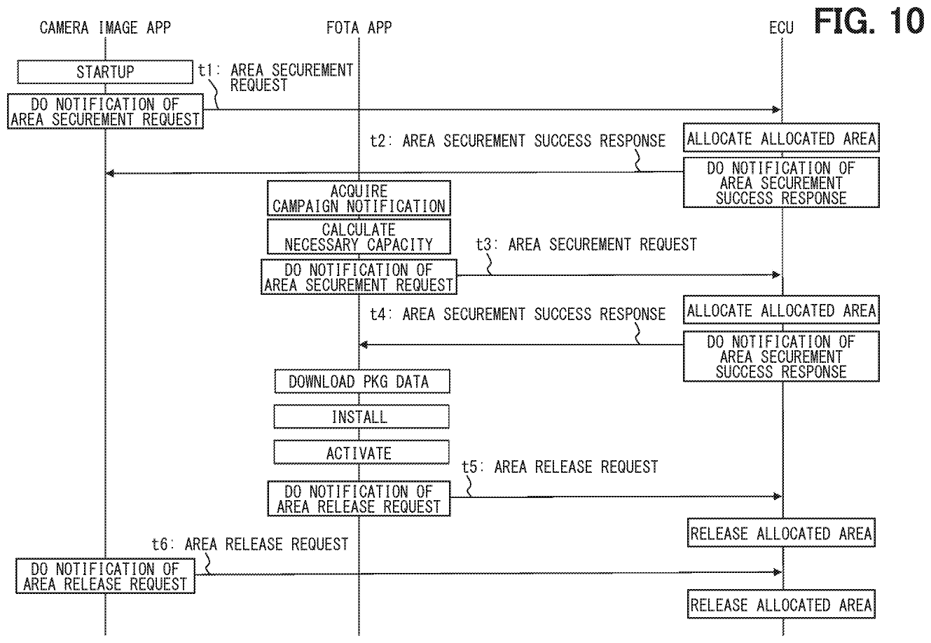

Hereinafter, a flow of processes, in a case where the area securement request application is a FOTA application and also the area allocation application is a camera image application, will be described with reference to FIGS. 10 to 13. The camera image application is an application that notifies a center of the image at an event occurrence, and is an application that notifies the controller 2 of the area securement request at the startup in preparation for the event occurrence. That is, until the event occurs, the allocated area of the camera image application is entirely the unused area. When the event occurs, a part of the allocated area of the camera image application becomes the used area. The FOTA application is an application that controls reprogramming of software in an ECU to be reprogrammed, and is an application that notifies the controller 2 of the area securement request upon receiving and acquiring a campaign notification transmitted from an OTA center.

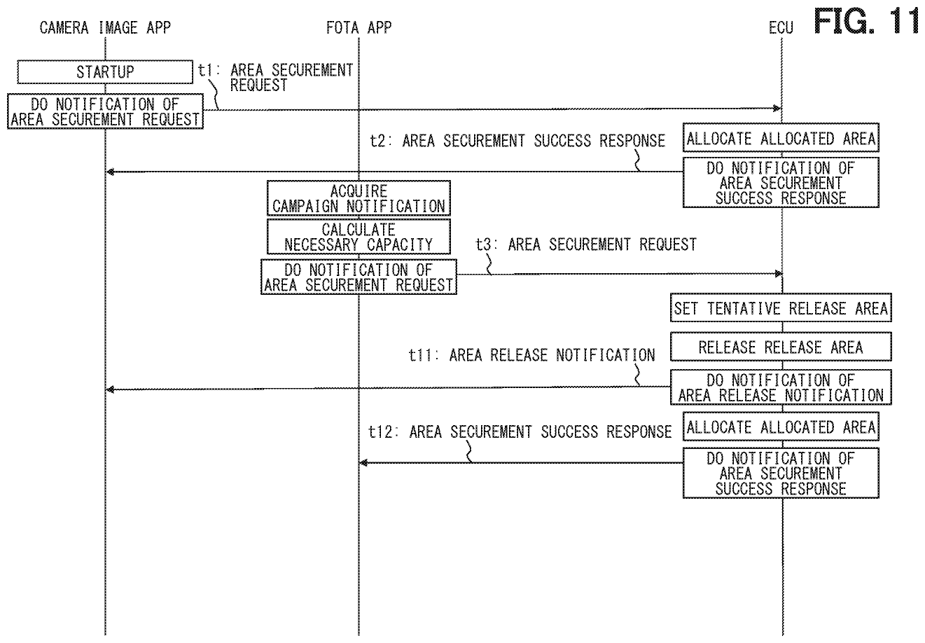

When a part of the unused area of the allocated area of the camera image application is not released as the release area in response to the area securement request from the FOTA application, processes shown in FIG. 11 are executed. Upon starting up an application and starting an application process, the camera image application notifies the controller 2 of the area securement request (t1). When notified of the area securement request from the camera image application, the controller 2 checks the unallocated area and determines whether the capacity of the unallocated area exceeds the request capacity. When determining that the capacity of the unallocated area exceeds the request capacity, the controller 2 allocates, as the allocated area for the camera image application, the capacity according to the area securement request in the capacity of the unallocated area, and notifies the camera image application of the area securement success response (t2). When receiving the area securement success response from the controller 2, the camera image application performs the capturing, stores the image in the memory. When the event occurs, the camera image application transmits the image stored in the memory to the center.

When the FOTA application starts the application process, it waits to acquire campaign notifications sent from the OTA center. When receiving and acquiring the campaign notification transmitted from the OTA center, the FOTA application analyzes the acquired campaign notification, calculates the capacity necessary for the area securement, and notifies the controller 2 of the area securement request (t3). When notified of the area securement request from the FOTA application, the controller 2 checks the unallocated area and determines whether the capacity of the unallocated area exceeds the request capacity. When determining that the capacity of the unallocated area exceeds the request capacity, the controller 2 allocates, as the allocated area of the FOTA application, the capacity according to the area securement request in the capacity of the unallocated area, and notifies the FOTA application of the area securement success response (t4).

When the controller 2 notifies the FOTA application of the area securement success response, the FOTA application waits to download the package data distributed from the OTA center. After downloading the package data distributed from the OTA center, the FOTA application installs the downloaded package data in the reprogramming target ECU, and activates the reprogramming target ECU after completion of the installation.

After completing the application process, the FOTA application notifies the controller 2 of an area release request (t5). When receiving the area release request from the FOTA application, the controller 2 releases the allocated area that has been allocated to the FOTA application. After completing the application process, the camera image application notifies the controller 2 of an area release request (t6). When receiving the area release request from the camera image application, the controller 2 releases the allocated area allocated to the camera image application.

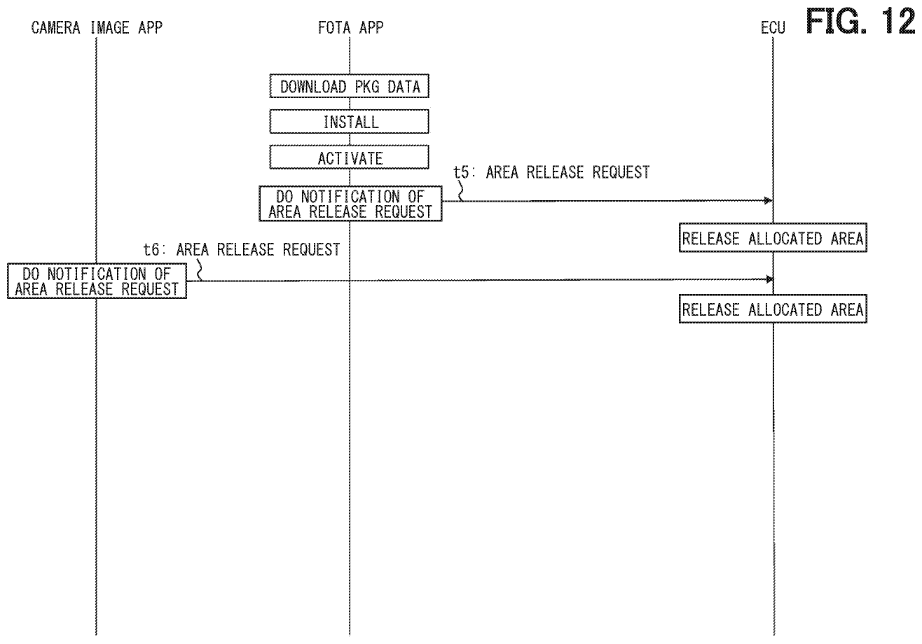

On the other hand, when a part of the unused area of the allocated area of the camera image application is released as the release area in response to the area securement request from the FOTA application, processes shown in FIGS. 11 and 12 are executed. In this case, when determining that the capacity of the unallocated area does not exceed the request capacity, the controller 2 determines whether the camera image application has an unused area equal to or larger than the threshold. When the controller 2 determines that the camera image application has the unused area equal to or larger than the threshold, the controller 2 determines the frequency of access to the allocated area of the camera image application and the remaining use period of the allocated area as described above, and sets the tentative release area. When determining that the total capacity exceeds the request capacity, the controller 2 releases the tentative release area as a release area, and releases a part of the unused area as a release area. When notifying the camera image application of the area release notification (t11), the controller 2 allocates the total capacity as the allocated area of the area securement request application, and notifies the FOTA application of the area securement success response (t12).

Upon receiving the notification of the area securement success response from the controller 2, similarly, after downloading the package data distributed from the OTA center, the FOTA application installs the downloaded package data in the reprogramming target ECU, and activates the reprogramming target ECU after completion of the installation.

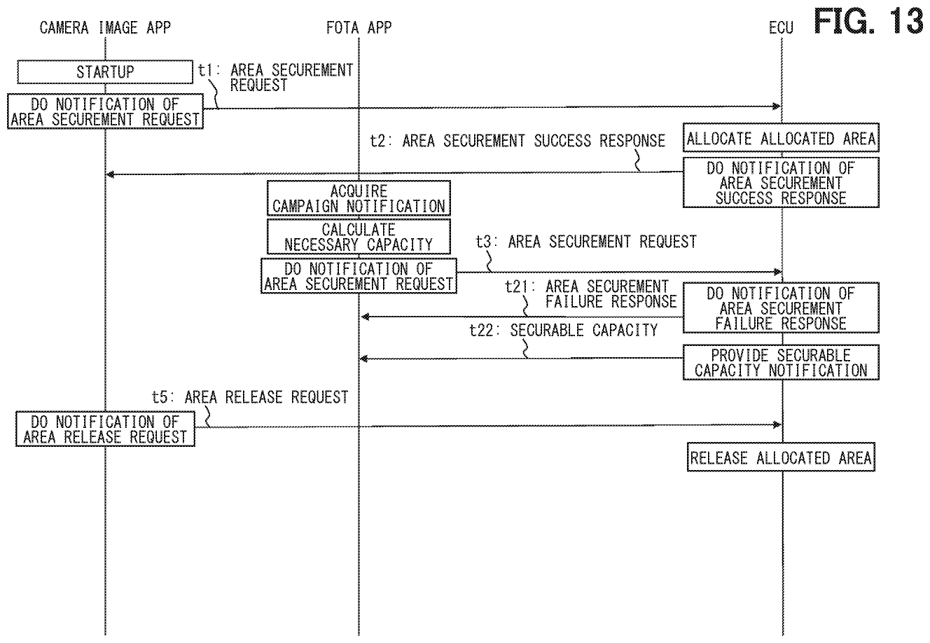

When a part of the unused area of the allocated area of the camera image application is not released as the release area in response to the area securement request from the FOTA application, processes shown in FIG. 13 are executed. In this case, when determining that the total capacity does not exceed the request capacity, the controller 2 notifies the FOTA application of the area reservation failure response (t21) and notifies the FOTA application of the securable capacity (t22).

The first embodiment described above can provide the following effects. Focusing on the situation that the unused area exists in the allocated area already allocated to the area-allocated application, in the ECU 1, when the capacity of the unallocated area of the storage 3 does not exceed the request capacity, a part of the unused area is released as the released area, and the total capacity of the unallocated area and the release area is allocated as the allocated area of the area securement request application. By releasing a part of the unused area as the release area and allocating the total capacity of the part of the unallocated area and the release area as the allocated area of the area securement request application, it is possible to secure the allocated area of the area securement request application. Thereby, when the capacity of the unallocated area of the storage 3 does not exceed the request capacity at the time of receiving the area securement request from the area securement request application, it is possible to appropriately allocate the allocated area of the area securement request application and perform appropriate operations.

In the ECU 1, among the area-allocated applications, the application whose frequency of access to the allocated area is less than the threshold and also total capacity of the unallocated area and the tentative release area exceeds the request capacity is selected as the area release application. A part of the unused area in the allocated area already allocated to the selected area release application is released as the release area. For the application that accesses the allocated area less frequently than the threshold, the unused area is less likely to shift to the used area. Therefore, it is possible to appropriately allocate the allocated area to the area securement request application while avoiding the influence on the area-allocated application.

In the ECU 1, among the area-allocated applications, the application, whose remaining use period of the allocated area is less than the threshold and also total capacity of the unallocated area and the tentative release area exceeds the request capacity, is selected as the tentative release area. A part of the unused area in the allocated area already allocated to the selected area release application is released as the release area. During the remaining use period of the allocated area, the unused area is less likely to shift to the used area. Therefore, it is possible to appropriately allocate the allocated area to the area securement request application while avoiding the influence on the area-allocated application.

In the ECU 1, first, it is determined whether the application whose access frequency to the allocated area is less than the threshold exists. After that, it is determined whether the application with the allocated area remaining use period less than the threshold exists. It is possible to select, as the release area application, the application of which access frequency to the allocated area is less than the threshold.

### Second Embodiment

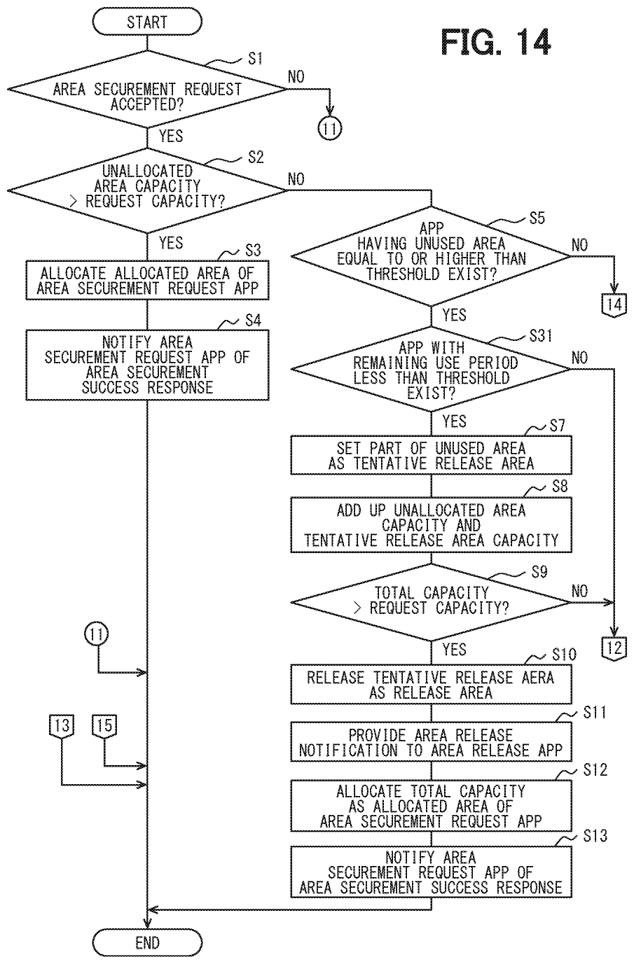

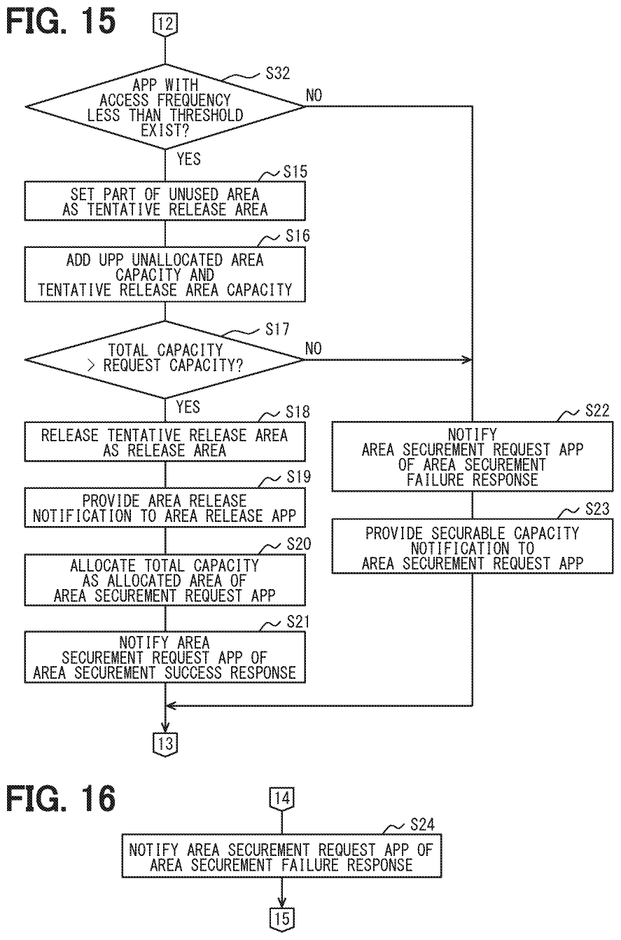

A second embodiment will be described with reference to FIG. 14 to FIG. 16. In the first embodiment, the application of which access frequency to the allocated area is less than the threshold is preferentially selected as the release area application. However, in the second embodiment, an application whose remaining use period of the allocated area is less than the threshold is preferentially selected as the release area application.

In this case, when determining that the application having an unused area equal to or larger than the threshold (S5: YES) exists, the controller 2 determines whether an application whose remaining use period of the allocated area is less than the threshold exists (S31). When the controller 2 determines that the application whose remaining use period of the allocated area is less than the threshold exists (S31: YES), it executes S7 and subsequent processes.

When determining that the no application whose remaining use period of the allocated area is less than the threshold exists (S41: NO), or when determining that the total capacity does not exceed the request capacity (S9: NO), the controller 2 determines whether the application whose frequency of the access to the allocated area is less than the threshold exists (S32). When determining that the application whose frequency of the access to the allocated area is less than the threshold exists (S32: YES), the controller 2 executes S15 and subsequent processes.

The second embodiment described above can provide the following effects. In the ECU 1, first, it is determined whether the application with the allocated area remaining use period less than the threshold exists. After that, it is determined whether the application with the frequency of the access to the allocated area less than the threshold exists. It is possible to select, as the release area application, the application of which remaining use period of the allocated area is less than the threshold.

### Third Embodiment

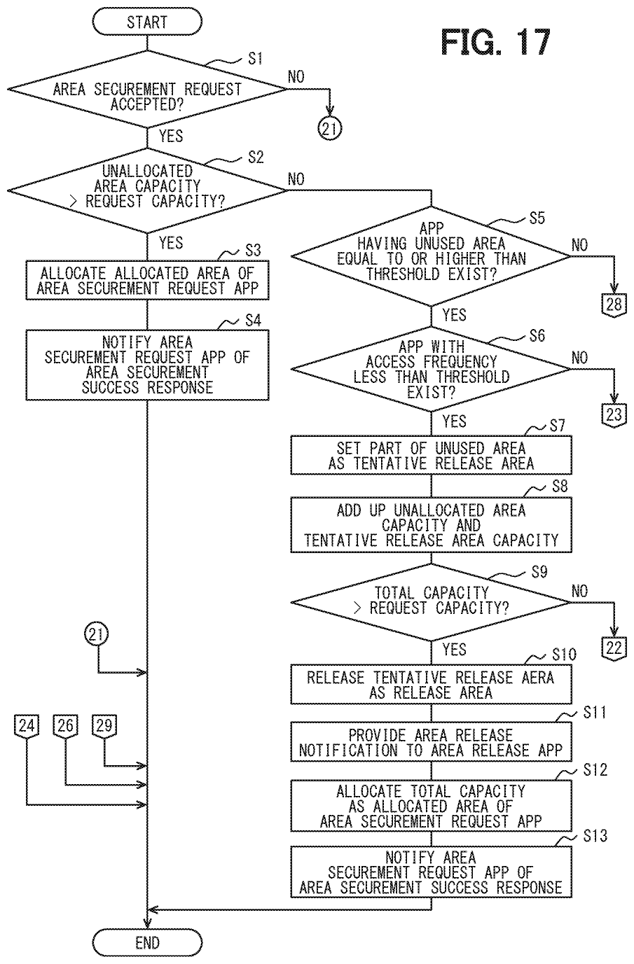

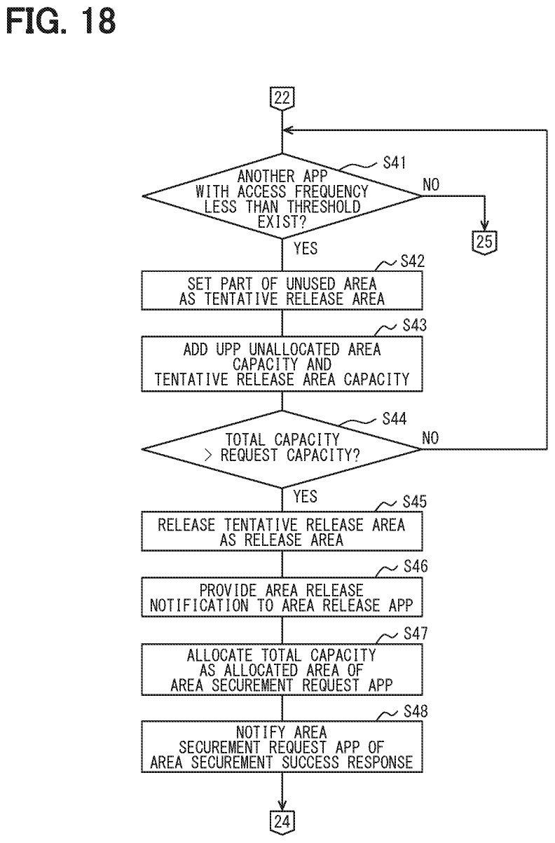

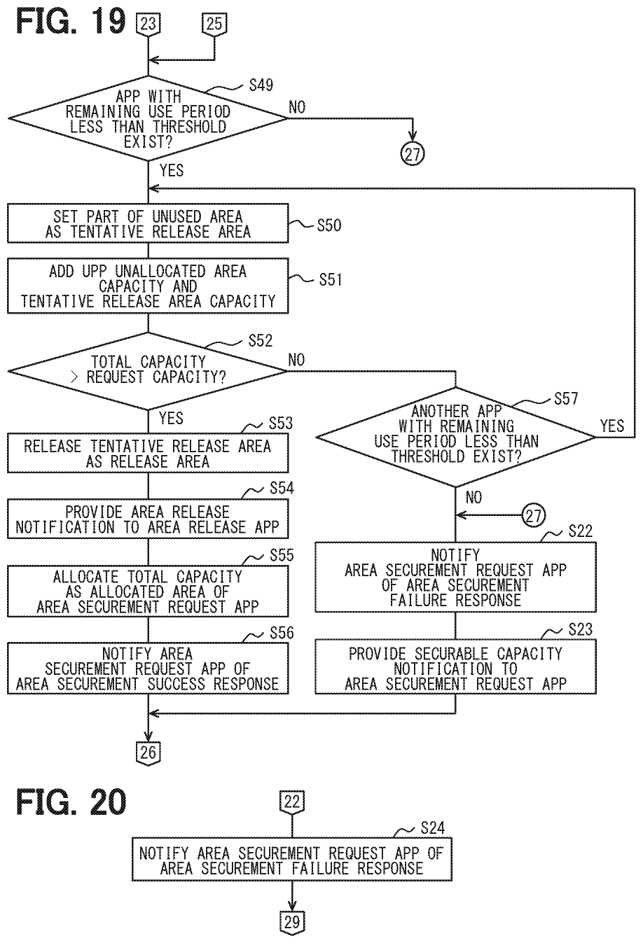

A third embodiment will be described with reference to FIG. 17 to FIG. 20. In the first embodiment, it is assumed that only one application whose access frequency to the allocated area is less than the threshold exists. However, in the third embodiment, it is assumed that multiple applications whose access frequency to the allocated area is less than the threshold exist. The multiple applications of which access frequencies to the allocated areas are less than the threshold are preferentially selected as the release area applications.

When determining that the application whose frequency of the access to the allocated area is less than the threshold exists (S6: YES) and that the total capacity does not exceed the request capacity (S9: NO), the controller 2 determines whether another application whose frequency of the access to the allocated area is less than the threshold exists (S41). When determining that another application whose frequency of the access to the allocated area is less than the threshold exists (S41: YES), the controller 2 executes S42 to S48 similar to S15 to S21. That is, the controller 2 adds up the capacity of the unallocated area and the capacity of the tentative release area for multiple applications whose access frequency to the allocated area is less than the threshold to calculate the total capacity. In this case, when determining that the total capacity does not exceed the request capacity (S44: NO), the controller 2 returns to S41 and repeats S41 and subsequent processes.

When determining that no application whose frequency of the access to the allocated area is less than the threshold exists (S6: NO), or when determining that another application whose frequency of the access to the allocated area is less than the threshold does not exist (S41: NO), the controller 2 determines whether the application whose remaining use period of the allocated area is less than the threshold exists (S49). When determining that another application whose remaining use period of the allocated area is less than the threshold exists (S49: YES), the controller 2 executes S50 to S56 similar to S15 to S21. In this case, when determining that the total capacity does not exceed the request capacity (S52: NO), the controller 2 determines whether another application whose remaining use period of the allocated area is less than the threshold exists (S57). When determining that another application whose remaining use period of the allocated area is less than the threshold exists (S57: YES), the controller 2 returns to S50 and repeats S50 and subsequent processes.

When determining that no application whose remaining use period of the allocated area is less than the threshold exists (S49: NO), or when determining that another application whose remaining use period is less than the threshold (S57: NO) does not exist, the controller 2 executes S22 and the subsequent processes.

The third embodiment described above can provide the following effects. In the ECU 1, when it is determined that the application of which access frequency to the allocated area is less than the threshold exists and that the total capacity does not exceed the request capacity, not determination of whether the application with the allocated area remaining use period less than the threshold exists but determination of whether the application with the allocated area access frequency less than the threshold exists is performed. It is possible to select, as the release area applications, multiple application of which access frequencies to the allocated areas are less than the threshold.

It may be assumed that there are multiple applications whose remaining use periods of the allocated areas are less than the threshold. When it is determined that the application of which request capacity of the allocated area is less than the threshold exists and that the total capacity does not exceed the request capacity, not determination of whether the application with the allocated area access frequency less than the threshold exists but determination of whether the application with the allocated area remaining use period less than the threshold exists may be performed. That is, the controller 2 may add up the capacity of the unallocated area and the capacity of the tentative release area for multiple applications whose remaining use period of the allocated area is less than the threshold to calculate the total capacity. According to such a configuration, it is possible to select, as the release area application, multiple application of which remaining use periods of the allocated areas are less than the threshold.

### Other Embodiments

While the present disclosure has been described based on the embodiments, the present disclosure is not limited to the embodiment or structure described herein. The present disclosure includes various modification examples or variations within the scope of equivalents. Furthermore, various combinations and formations, and other combinations and formations including one, more than one or less than one element may be included in the scope and the spirit of the present disclosure.

The example of setting a part of the unused area, for example, “80%” as the tentative release area has been described. However, the ratio of the area set as the tentative release area to the unused area may be arbitrary. Also, the ratio of the area set as the tentative release area to the unused area may be a fixed value, or may be a variable value according to the capacity of the unused area, for example. When the capacity of the unused area is relatively large, the ratio set as the tentative release area may be relatively large. When the capacity of the unused area is relatively small, the ratio set as the tentative release area may be relatively small.

The controller and the method according to the present disclosure may be achieved by a dedicated computer provided by constituting a processor and a memory programmed to execute one or more functions embodied by a computer program. Alternatively, the controller and the method thereof described in the present disclosure may be implemented by a dedicated computer provided by configuring a processor with one or more dedicated hardware logic circuits. Alternatively, the controller and the method thereof described in the present disclosure may be implemented by one or more dedicated computers configured by a combination of a processor and a memory programmed to execute one or more functions and a processor configured by one or more hardware logic circuits. The computer program may be stored in a computer-readable non-transitional tangible recording medium as an instruction to be executed by the computer.

The ECU 1 may output the storage allocated area to each application. For example, the ECU 1 may transmit the storage area size for each application to a different ECU via the in-vehicle network, and may display a figure showing the storage area for each application on a display of a computer. Further, the ECU may include a receiver that receives data from a camera, and store the received data, for example, an image in the allocated area allocated to the camera application.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

### DESCRIPTION OF REFERENCE NUMERALS

In the drawing, the reference numeral of “1” corresponds to an ECU (electronic control unit), the reference numeral of “2” corresponds to a controller, the reference numeral of “2a” corresponds to an area securement request acceptance unit, the reference numeral of “2b” corresponds to an area determination unit, the reference numeral of “2c” corresponds to an area release unit, the reference numeral of “2d” corresponds to an area allocation unit, and the reference numeral of “3” corresponds to a storage.

1. An electronic control unit that causes a plurality of applications to share a storage, the electronic control unit comprising:
an area securement request acceptance unit configured to accept an area securement request from an area securement request application;
an area determination unit configured to determine whether a capacity of an unallocated area of the storage exceeds a request capacity specified by the area securement request upon acceptance of the area securement request from the area securement request application;
an area release unit configured to release, as a release area, at least a part of unused area of the allocated area already allocated to an area-allocated application when a capacity of the unallocated area of the storage does not exceed the request capacity; and
an area allocation unit configured to allocate a total capacity of at least a part of the capacity of the unallocated area and a capacity of the release area as the allocated area in response to the area securement request.

2. The electronic control unit according to claim 1, wherein
the area release unit is configured to determine whether an application whose access frequency to the allocated area is less than a threshold exists,
when determining that the application whose access frequency to the allocated area is less than the threshold exists, the area release unit
selects the determined application as an area release application and
releases, as the release area, at least a part of the unused area of the allocated area already allocated to the selected area release application.

3. The electronic control unit according to claim 2, wherein
the area release unit is configured to select, as the area release application, a plurality of applications each whose access frequency to the allocated area is less than a threshold.

4. The electronic control unit according to claim 2, wherein
when determining that the application whose access frequency to the allocated area is less than the threshold does not exist, the area release unit determines whether an application whose remaining use period of the allocated area is less than a threshold exists,
when determining that the application whose remaining use period of the allocated area is less than the threshold exists, the area release unit
selects the determined application as an area release application and
releases, as the release area, at least a part of the unused area of the allocated area already allocated to the selected area release application.

5. The electronic control unit according to claim 1, wherein
the area release unit is configured to determine whether an application whose remaining use period of the allocated area is less than a threshold exists,
when determining that the application whose remaining use period of the allocated area is less than the threshold exists, the area release unit
selects the determined application as an area release application and
releases, as the release area, at least a part of the unused area of the allocated area already allocated to the selected area release application.

6. The electronic control unit according to claim 5, wherein
the area release unit is configured to select, as the area release application, a plurality of applications each whose remaining use period of the allocated area is less than a threshold.

7. The electronic control unit according to claim 5, wherein
when determining that the application whose remaining use period of the allocated area is less than the threshold does not exist, the area release unit determines whether an application whose access frequency to the allocated area is less than a threshold exists,
when determining that the application whose access frequency to the allocated area is less than the threshold exists, the area release unit
selects the determined application as an area release application and
releases, as the release area, at least a part of the unused area of the allocated area already allocated to the selected area release application.

8. The electronic control unit according to claim 1, wherein
the storage is a nonvolatile memory, and
the plurality of applications share the nonvolatile memory.

9. An area allocation method for causing an electronic control unit to cause a plurality of applications to share a storage, the method comprising:
accepting an area securement request from an area securement request application;
determining whether a capacity of an unallocated area of the storage exceeds a request capacity specified by the area securement request;
releasing, as a release area, at least a part of unused area of the allocated area already allocated to an area-allocated application when a capacity of the unallocated area of the storage does not exceed the request capacity; and
allocating a total capacity of at least a part of the capacity of the unallocated area and a capacity of the release area as the allocated area in response to the area securement request.

10. A computer-readable non-transitory storage medium storing an area allocation program for a controller of an electronic control unit that causes a plurality of applications to share a storage, the program causing the controller to:
accept an area securement request from an area securement request application;
determine whether a capacity of an unallocated area of the storage exceeds a request capacity specified by the area securement request;
release, as a release area, at least a part of unused area of the allocated area already allocated to an area-allocated application when a capacity of the unallocated area of the storage does not exceed the request capacity; and
allocate a total capacity of at least a part of the capacity of the unallocated area and a capacity of the release area as the allocated area in response to the area securement request.

11. The electronic control unit according to claim 1, further comprising
a processor that serves as the area securement request acceptance unit, the area determination unit, the area release unit, and the area allocation unit.
